(19) United States
(12) Patent Application Publication
(10) Pub. No.: US 2011/0139534 A1
(43) Pub. Date: Jun. 16, 2011

(54) MOTOR VEHICLE AND BODY FLOOR STRUCTURE FOR A MOTOR VEHICLE

(75) Inventors: Stanislaw KLIMEK, Frankfurt (DE); Juergen HULBERT, Eltville (DE)

(73) Assignee: GM GLOBAL TECHNOLOGY OPERATIONS LLC, Detroit, MI (US)

(21) Appl. No.: 12/960,230

(22) Filed: Dec. 3, 2010

(30) Foreign Application Priority Data
Dec. 3, 2009 (DE) 102009056852.2

(51) Int. Cl. B62D 25/20; B60K 13/04

(52) U.S. Cl. 180/309; 296/193.07

(57) ABSTRACT

A body floor structureis provided, which, within the center tunnel, includes, but is not limited to a first receiving clearance for receiving a first energy storage device for the storage of energy for driving the vehicle and in the rear seat region includes, but is not limited to a second receiving clearance for receiving a second energy storage device for the storage of energy for driving the vehicle and a motor vehicle, specifically a hybrid vehicle, which comprises this body floor structure.

### CROSS REFERENCE TO RELATED APPLICATION

This application claims priority to German Patent Application No. 102009056852.2, filed Dec. 3, 2009, which is hereby incorporated by reference in its entirety.

### TECHNICAL FIELD

The technical field relates to a motor vehicle, particularly to the arrangement of energy storage devices for the storing of energy for driving the vehicle, and to a body floor structure for the motor vehicle. The motor vehicle specifically concerns a hybrid vehicle.

### BACKGROUND

Quite a number of demand are made on the arrangement of energy storage units, particularly in a passenger motor vehicle. Top priority here are the technical safety demands. For example, a fuel tank, with respect to the risk of leaking fluid, should be arranged in the vehicle body in as favorable and stable as possible a manner. However, demands in terms of space available in the passenger compartment and in the luggage compartment as well as environmental protection and the overall mass of the vehicle also play a decisive role.

In most known motor vehicles the fuel tank is arranged in the rear seat region of the body floor structure. Through this arrangement it is mounted susceptible to forces caused by the impact energy in the case of collisions in the rear or lateral vehicle region. Stiffeners, that have become necessary in the vehicle body because of this, in turn lead to an increase in weight of the overall vehicle. In the publications EP 0 067 602 A1 and DE 198 41 331 C2 it is therefore proposed to arrange the fuel tank in the center tunnel of the body floor structure, in which with conventional vehicles components of the exhaust system are arranged. From EP 0 067 602 A1 a motor vehicle with rear wheel drive and rear motor is known in this regard, wherein the fuel tank instead of a driveshaft is provided in the center tunnel. From DE 198 41 331 C2 on the other hand a passenger motor vehicle, specifically a convertible vehicle, is known, wherein the fuel tank is arranged above the driveshaft in an elevation of the center tunnel.

As part of environmental protection hybrid vehicles are increasingly being developed. There, at least two energy converters and two energy storage devices installed in the vehicle are provided for driving the vehicle. The energy converters are for example electric, spark-ignition or diesel engines, the energy storage devices for example batteries, gas, gasoline or diesel tanks Through the mixing of different drive possibilities, hybrid vehicles are particularly economical in fuel consumption. In such vehicles, power-split or parallel arrangements of two energy storage units are mostly employed.

At least one object is to state a hybrid vehicle as well as a body floor structure for said hybrid vehicle in order to guarantee a safe and optimal arrangement of the energy storage units.

### SUMMARY

According to an embodiment of the invention, the body floor structure of a motor vehicle comprises a center tunnel and a rear seat region, wherein within the center tunnel a first receiving clearance for receiving a first energy storage device, for the storage of energy for driving the motor vehicle and in the rear seat region a second receiving clearance for receiving a second energy storage device, for the storage of energy for driving the vehicle is provided.

Through such a configuration of the body floor structure the utilization spaces freely available in the vehicle floor are efficiently utilized without simultaneous loss of loading space. In that an energy storage unit is provided in the center tunnel approximately at the height of the vehicle center said energy storage unit can be protected from deformations and other damages due to the absorption of impact energy and the weight distribution in the vehicle can be optimized since the weights connected with this are located far down below, near the vehicle center.

Energy for driving the vehicle in this case means that the energy stored in the energy storage device is utilized for driving the energy converters which in turn act on the axles of the vehicle and convert the energy supplied to them into movement energy. Thus, the energy storage devices according to the invention are not starter batteries. In addition, the first and the second energy storage devices can be designed for storing the same type of energy or hold various types of energy. Specifically, the energy storage devices are fuel tanks for the storage of gasoline or diesel, gas tanks or battery stacks of an electric motor.

Preferably the first and second receiving clearance are each designed as anchorage region with integrated opening for receiving a fuel tank, a gas tank or a battery stack provided in the body or as recess in the body for receiving a gas tank or a battery stack. In this case, different types of energy storage units can be arranged in the first and the second receiving clearance. Thus, a fuel tank can be integrated in the opening provided in the body or a battery stack of an electric motor or gas tank can be arranged in the receiving clearances.

For exhaust gas operated vehicles, that is with vehicles wherein at least one energy converter is an external ignition engine, for example a spark-ignition engine or a compression ignition engine, for example a diesel engine, an exhaust system is additionally necessary since these emit harmful substances to the environment during operation. In an exemplary embodiment the body floor structure therefore comprises additional installation space for an exhaust system of a motor vehicle outside the center tunnel. This makes possible a simple, space-saving and safe arrangement of the exhaust system without parts of the technical drive functions having to be changed. In addition, sufficient space for the installation of an energy storage unit with adequate receiving capacity is made available within the center tunnel as a result.

A motor vehicle comprising the body floor structure described above is also stated. A motor vehicle, comprising the body floor structure described above has the advantage that by receiving an energy storage unit in the center tunnel of the body floor structure more space for other vehicle components such as additional energy storage units or parts of an exhaust system is created in the rear seat region of the body floor structure. At the same time, through such a construction, the entire space that is available in the vehicle floor can be efficiently utilized while the weight acting in the rear seat region of the vehicle is reduced at the same time and the axle forces are better balanced.

In a preferred exemplary embodiment the motor vehicle is a hybrid vehicle. Through the combination of different types of energy their respective advantages can thus be combined and substantially more fuel-saving driving made possible. The configuration of the vehicle floor according to the invention in this case makes possible utilizing the energy storage devices for different types of energy for driving the vehicle, without corresponding changes in the technical driving functions having to be carried out.

In the first receiving clearance of the body floor structure a first energy storage device, and in the second receiving clearance, a second energy storage device can be arranged in this case. Through such a connection simple and accurately fitting fixing of the energy storage devices can be achieved without additional transverse braces for stiffening have to be integrated in the body floor structure. Through the accurately fitting fixing the first energy storage device can be installed in the center tunnel of the body floor structure in a stable manner, as a result of which the safety of fixing of the energy storage device can be further improved. This type of arrangement of an energy storage unit in the center tunnel of the body floor structure thus fulfills a dual function, on the one hand as stiffening element of the center tunnel and as damper for impact energy acting on the energy storage unit on the other hand.

Here, the first energy storage device can be positively connected to the first receiving clearance and the second energy storage device to the second receiving clearance. Through the positive connections between the energy storage devices and the body floor structure of the vehicle these can be mounted in a stable manner. Because of this, the displaceability of the energy storing devices within the receiving clearances when subjected to impact energy and including the risk of breaking out or destroying of the energy storage devices can be reduced without additional stiffening elements in the body structure being necessary. In this way, a greatest possible absorption capacity of impact energy with the lowest weight of the overall vehicle possible is achieved.

The first and the second energy storage device in a preferred exemplary embodiment each comprise one or several energy storage units. For example, in a vehicle operated with gas, one can mostly find several installed gas tanks which are interconnected in a fluid-conducting manner in order to accommodate as much compressed gas as possible and thus to increase the range of the vehicle. With hybrid electric vehicles, too, one frequently finds several power sources for example batteries in order to provide as high as possible a storage capacity for electric power for the electric drive system. Usually, lead-acid batteries with high energy density, nickel batteries, such as Ni/Cd or NiMH batteries, or lithium battery systems, such as lithium ion or lithium polymer batteries are employed in hybrid drives.

In an embodiment of the invention the first energy storage device is a fuel tank, specifically a gasoline or diesel tank and the second energy storage device comprises gas tanks Through the combination of the two drive types the respective advantages can be combined with each other resulting in an optimal utilization of the existing energy, which means consuming only as much energy as is really necessary. Thus the hybrid drive for example allows driving with gas in normal mode and to change over to gasoline only if there is a shortage of gas. Changing over between gas and tank content in this case can be effected fully automatically or manually through the driver.

Depending on the types of energy available, other combinations can also be employed, however. For example the first energy storage device can be a fuel tank and the second energy storage device can comprise a battery stack. For example an electric motor can supply additionally necessary drive power required in certain situations such as accelerations or uphill driving, so that a gasoline engine can operate evenly and smoothly and the fuel consumption can thus be optimized.

In a further embodiment of the invention the first energy storage device comprises gas tanks and the second energy storage device a battery stack. Both, that is the first and the second energy storage device can also comprise battery stacks and thus drive the vehicle as electric vehicle.

In the case of exhaust gas operated vehicles an exhaust system can be additionally arranged in the installation space of the body floor structure. By doing so it is ensured that the exhaust system is mounted in the safe region of the body floor structure without simultaneously having an effect on the structure and arrangement of the energy storage devices.

In a preferred embodiment the exhaust system in this case comprises an exhaust pipe which is arranged running parallel to the center shaft of the body floor structure, a first catalytic converter arranged in the region of the center shaft of the body floor structure and a second catalytic converter including exhaust pipe arranged in the rear seat region of the body floor structure. This arrangement has the advantage that the entire free space available in the vehicle floor can be efficiently utilized, the exhaust system is mounted in the safe region without influencing structure and shape of the first energy storage devices. In addition, the catalytically acting devices in the exhaust system of the vehicle are held mechanically stable in a safe region of the vehicle floor as a result. In addition, space that has become vacant in the rear seat region of the body floor structure through the arrangement of the first energy storage unit in the center tunnel, a catalytic converter with large volume can be arranged, which is simultaneously decoupled from engine vibrations which favors lower exhaust backpressures and thus a lower fuel consumption of the vehicle.

In addition, a starter battery can be arranged in the rear seat region of the body floor structure. This has the advantage that compared with vehicles where the starter battery is arranged in the engine compartment, said starter battery is mounted protected from impact forces acting during a head-on collision and possible mechanical destruction of the battery housing connected with this.

In summary it must be noted that with the embodiments of the present invention a safe and optimal arrangement of vehicle components, particularly of energy storage devices in a motor vehicle is guaranteed. Through the arrangement of a first energy storage device in the center tunnel of the body floor structure it can be advantageously mounted protected from forces caused through impact energy and thus significantly increase the safety of a motor vehicle. As a result, additional stiffeners in and thus material can in turn be saved, which result in a significant weight reduction of the overall vehicle. In addition, the space that has become vacant in the rear seat region of the body floor structure as a result can be utilized for the arrangement of additional vehicle components such as for example a second energy storage device, a catalytic converter with large volume or a starter battery.

With the embodiment of the invention it is thus achieved that the entire vacant space available in the vehicle floor is efficiently utilized, the weight with respect to the gross weight is reduced, with simultaneously improved balancing of the axle forces and the energy in the event of a collision is significantly better absorbed through the positive connection of the vehicle components to the body floor structure, and said components are thus safely mounted.

### BRIEF DESCRIPTION OF THE DRAWINGS

The present invention will hereinafter be described in conjunction with the following drawing figures, wherein like numerals denote like elements, and:

FIG. 1 shows a schematic top view of a body floor structure following arrangement of the energy storage devices according to a first embodiment of the invention;

FIG. 2 shows a schematic top view of a body floor structure following arrangement of the energy storage devices according to a second embodiment of the invention;

FIG. 3 shows a schematic top view of a body floor structure following arrangement of the energy storage devices according to a third embodiment of the invention;

FIG. 4 shows a schematic top view of a body floor structure following arrangement of the energy storage devices according to a fourth embodiment of the invention;

FIG. 5 shows a schematic top view of a comparative body floor structure following arrangement of the energy storage devices; and

FIG. 6 shows a schematic top view of an additional comparative body floor structure following arrangement of the energy storage devices.

### DETAILED DESCRIPTION

The following detailed description is merely exemplary in nature and is not intended to limit application and uses. Furthermore, there is no intention to be bound by any theory presented in the preceding background or summary or the following detailed description.

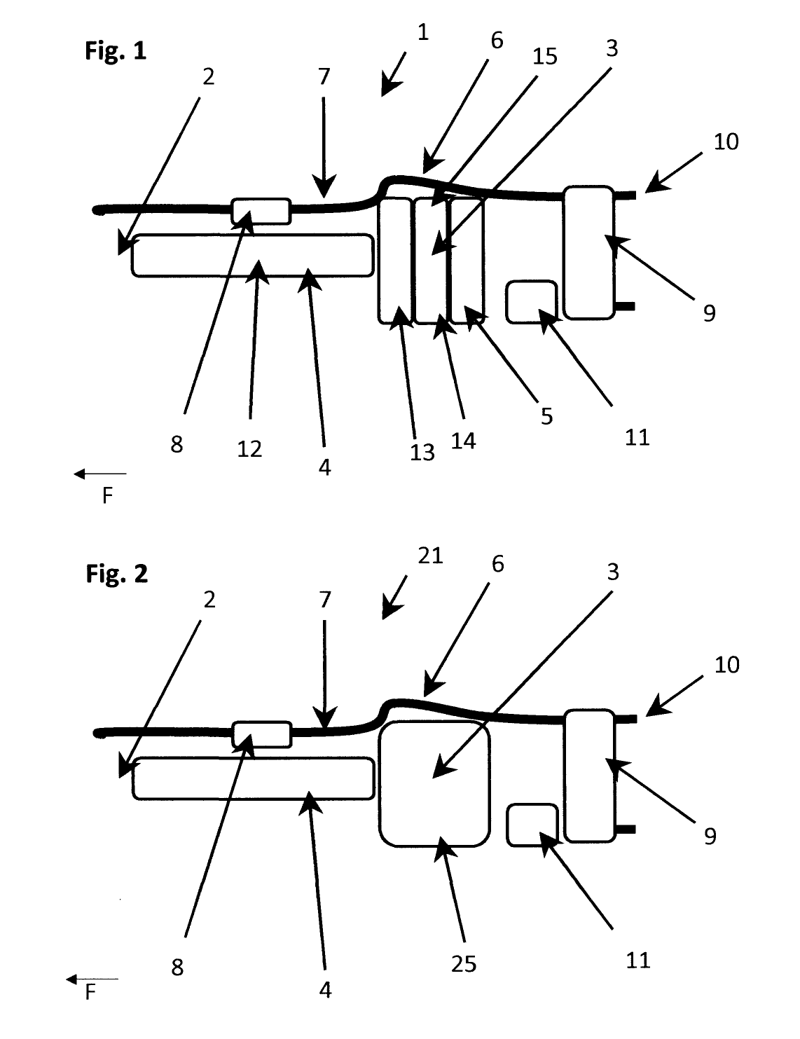

FIG. 1 shows a schematic top view of a body floor structure 1 of a motor vehicle, following arrangement of the energy storage units 4, 5 for the storage of energy for driving the vehicle according to a first embodiment of the invention. The body floor structure 1 in this case comprises a passenger compartment in which in the longitudinal center a center tunnel 2 running between engine compartment and rear axle is mounted, and opposite to the driving direction F a rear seat region 3 following this. Within the center tunnel 2 a first receiving clearance (not shown) is provided here, in which a first energy storage device 4 for the storage of energy for driving the vehicle is arranged. The rear seat region 3 of the body floor structure 1 comprises a second receiving clearance (not shown), in which a second energy storage unit 5 for the storage of energy for driving the vehicle is arranged.

In addition, an exhaust system 6 is shown, which is arranged in an installation space (not shown) of the body floor structure. In this case, this is provided outside the center tunnel 2. In addition, the first energy storage device 4 is positively connected to the first receiving clearance of the body floor structure 1, completely filling out the space made available to it. In addition, the second energy storage device 5 is also positively connected to the second receiving clearance and completely fills out the space made available to it.

With the exemplary embodiment shown in FIG. 1 the first energy storage device 4 comprises an energy storage unit 11 which extends in vehicle longitudinal direction in the first receiving clearance in the center tunnel 2 of the body floor structure 1. The second energy storage device 5 comprises three energy storage units 12,13,14, which are arranged parallel to one another transversely to the vehicle longitudinal direction in the second receiving clearance of the body floor structure 1.

Here, the energy storage unit 11 of the first energy storage device 4 is a fuel tank while the energy storage units 12, 13, 14 of the second energy storage device 5 are designed as inter-connected fluid-conducting gas tanks

In addition, FIG. 1 shows that the exhaust system comprises an exhaust pipe 6 which extends in vehicle longitudinal direction parallel to the tunnel wall of the center tunnel 2 at a close distance from said tunnel wall. With the exhaust pipe 6, a first catalytically acting device, also called first catalytic converter 7, is arranged in the region of the center tunnel of the body floor structure. The exhaust pipe 6 terminates in the rear seat region 3 of the body floor structure 1 in a second catalytic converter 8 arranged transversely to the vehicle longitudinal direction, which catalytic converter extends to the rear vehicle end and which is followed by an exhaust pipe 9.

In the exemplary embodiment of FIG. 1 a starter battery 10 is additionally arranged in the rear seat region 3 of the body floor structure 1 between the second energy storage device 5 and the second catalytic converter 8.

FIG. 2 to FIG. 4 show additional embodiments of the body floor structure according to the invention. Here, components with same design or function bear the same reference characters as in FIG. 1.

FIG. 2 shows a schematic top view of a body floor structure 21 of a motor vehicle, following arrangement of the energy storage devices 4, 25 according to a second embodiment of the invention. This second embodiment of the body floor structure 21 according to the invention differs from the body floor structure 1 shown in FIG. 1 in that the second energy storage device 25 comprises an energy storage unit 26 which is embodied as battery stack and thus as storage unit for the electric power for the electric drive systems of a hybrid electric vehicle. This is arranged transversely to the vehicle longitudinal direction in the second receiving clearance of the body floor structure 21.

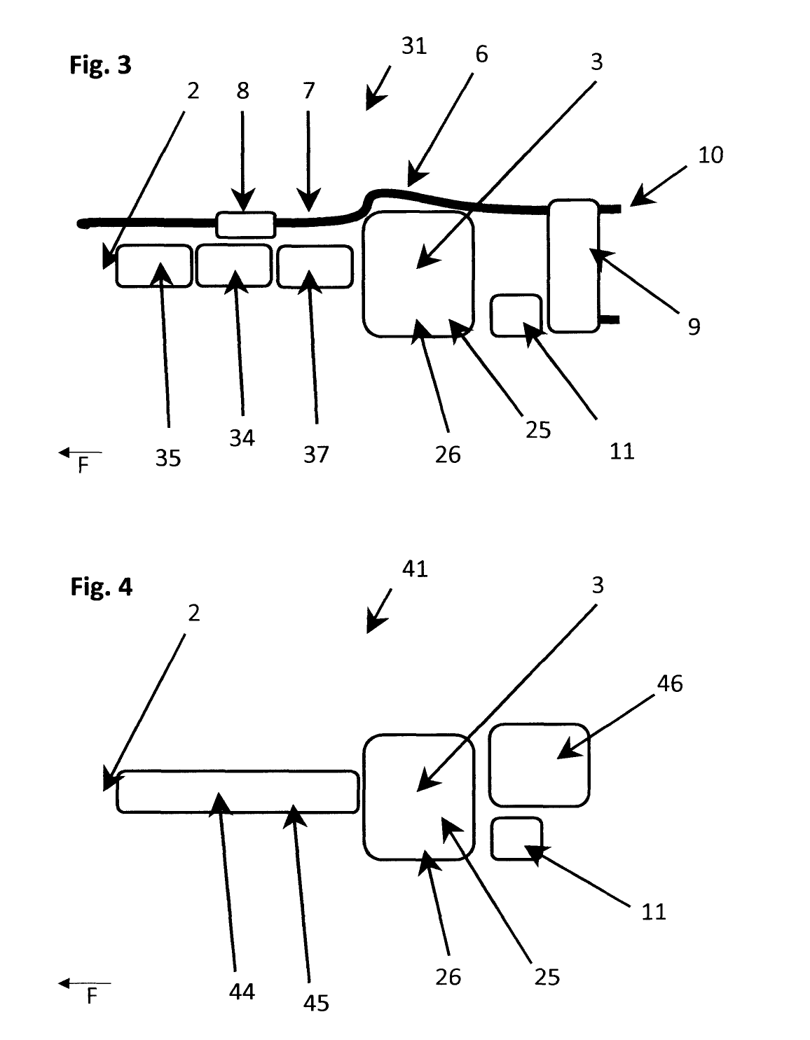

FIG. 3 shows a schematic top view of a body floor structure 31 of a motor vehicle following arrangement of the energy storage devices 34, 25 according to a third embodiment of the invention. Here, components with same design or function bear the same reference characters as in FIG. 2. With this third embodiment of the body floor structure 31 according to the invention the first energy storing device 34 comprises 3 energy storage units 35,36,3 which in vehicle longitudinal direction are arranged in the first receiving clearance of the body floor structure 31. Here, the gas tanks 35,36,37 are arranged next to one another and, viewed in their longitudinal direction, offset to one another. This results in that the gas tanks 35,36,37 in the event of a collision and the shock forces active in the process can give way into the vacant spaces.

FIG. 4 shows a schematic top view of a body floor structure 41 of a motor vehicle following arrangement of the energy storage devices 34,35,36 according to a fourth embodiment of the invention. Here, components with the same design or function bear the same reference characters as in FIG. 2. With this third embodiment of the invention the vehicle is operated purely as electric vehicle. The first and the second energy storage device 25,44 in this case each comprise an energy storage unit 26,45 which is embodied as battery stack and thus as a storage unit for the electric power for the electric drive systems of the vehicle. Since electric vehicles do not emit any harmful exhaust gas an exhaust system compared with exhaust gas operated vehicles is not provided. In the rear seat region 3 of the body floor structure 41 space for additional vehicle components such as for example a third energy storage device 46 which is likewise designed as battery stack is created as a result. Here, the first energy storage device 45 drives an electric motor as first energy converter which transmits movement energy to the front wheels for the locomotion of the vehicle. The second and third energy storage devices 25,46 drive a further electric motor which in turn transmits movement energy on to the rear wheels of the vehicle.

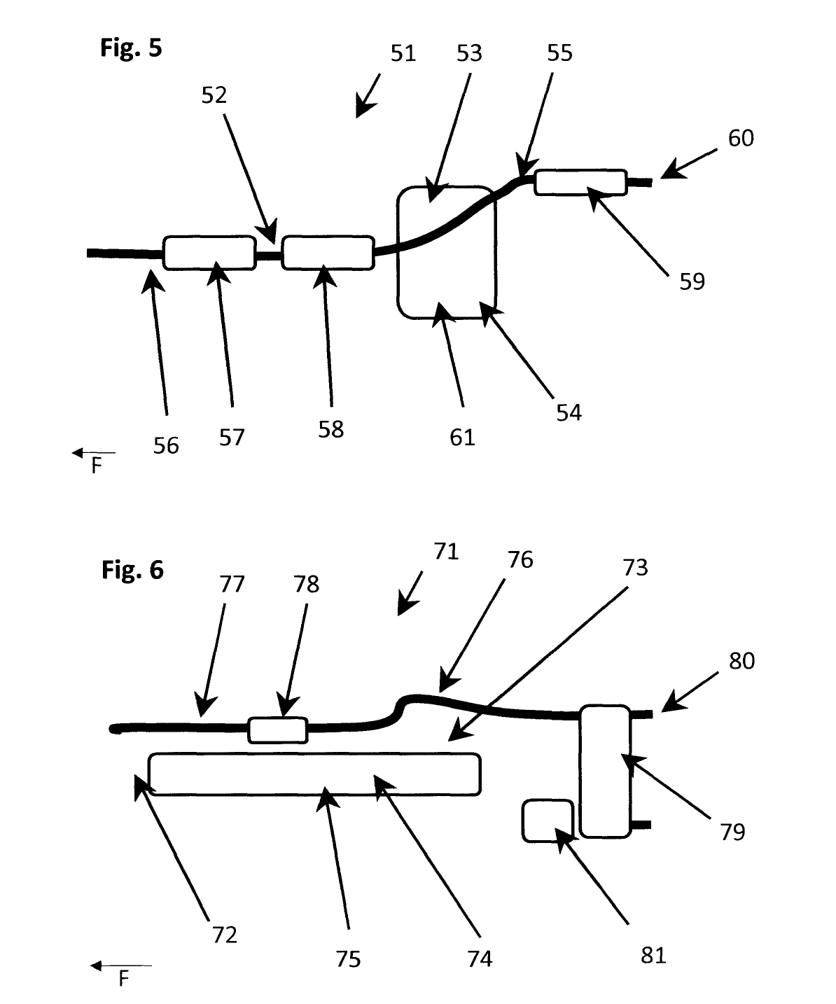

FIG. 5 and FIG. 6 by comparison show arrangements from body floor structures and energy storage devices. FIG. 5 in this case shows a schematic top view of a body floor structure following arrangement of an energy storage device. The body floor structure 51 in this case again comprises a passenger compartment with center tunnel 52 running in the longitudinal center as well as a rear seat region 53. Here, a receiving clearance (not shown) is provided in the rear seat region 53 of the body floor structure 51 in which a first energy storage device 54 is arranged. In this exemplary embodiment the motor vehicle comprises only one single energy storage device. The energy storage device in this case comprises an energy storage unit 61 which is designed as fuel tank. In addition, an exhaust system 51 having an exhaust pipe 56 running through the center tunnel 52 as well as two catalytic converters 57,58 mounted in the center tunnel 52, a third catalytic converter 59 arranged in the rear seat region 53 in vehicle longitudinal direction and a following exhaust pipe 60, is provided.

FIG. 6 shows a schematic top view of a further body floor structure following arrangement of an energy storage device. In this case, an energy storage device 74 comprising a single energy storage unit 75 designed as fuel tank is arranged in the center tunnel 72 of a body floor structure 71. In addition, FIG. 6 shows an exhaust system 76 which comprises an exhaust pipe 77 running in parallel and at a close distance from the center tunnel 72 and a first catalytic converter 78 arranged in vehicle longitudinal direction in the region of the center tunnel 72. The exhaust pipe 77 terminates in a second catalytic converter 79 arranged in the rear seat region 73 of the body floor structure 71 transversely to the vehicle longitudinal direction, which extends towards the rear vehicle end and which is followed by an exhaust pipe 80. In addition a starter battery 81, which is arranged in the rear seat region 73 of the body floor structure 71, is shown.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1-15. (canceled)

16. A body floor structure of a motor vehicle, comprising:
a center tunnel;
a first receiving clearance within the center tunnel configured to received a first energy storage device for storage of energy; and
a rear seat region comprises a second receiving clearance configured to receive a second energy storage device for storage of energy.

17. The body floor structure according to claim 16, wherein the first receiving clearance is an anchorage region with an integrated opening configured to receive a tank for an electric motor.

18. The body floor structure according to claim 16, wherein the first receiving clearance is an anchorage region with an integrated opening configured to receive a battery stack for an electric motor.

19. The body floor structure according to claim 16, wherein the second receiving clearance is an anchorage region with an integrated opening configured to receive a tank for an electric motor.

20. The body floor structure according to claim 16, wherein the second receiving clearance is an anchorage region with an integrated opening configured to receive a battery stack for an electric motor.

21. The body floor structure according to claim 16, further comprising an installation space for an exhaust system outside the center tunnel.

22. The body floor structure according to claim 16, the first energy storage device is positively connected to the first receiving clearance and the second energy storage device is positively connected to the second receiving clearance.

23. The body floor structure according to claim 16, wherein the first energy storage device and the second energy storage device an energy storage unit configured to store energy for driving the motor vehicle.

24. The body floor structure according to claim 16, wherein the first energy storage device is a fuel tank.

25. The body floor structure according to claim 16, wherein the second energy storage device is a fuel tank.

26. The body floor structure according to claim 16, wherein the second energy storage device comprises a battery stack.

27. The body floor structure according to claim 16, wherein the first energy storage device is a gas tank and the second energy storage device comprises a battery stack.

28. The body floor structure according to claim 16, the first energy storage device comprises a battery stack and the second energy storage device comprises a second battery stack.

29. The body floor structure according to claim 21, wherein the exhaust system is arranged in the installation space.

30. The body floor structure according to claim 29,
wherein the exhaust system of the motor vehicle comprises an exhaust pipe that is arranged in the installation space running substantially parallel to the center tunnel, and
wherein a first catalytic converter is arranged in a region of the center tunnel and a second catalytic converter is arranged in the rear seat region.

31. The body floor structure according to claim 16, further comprising a starter batter arranged in the rear seat region.
